(19) United States
(12) Patent Application Publication
(10) Pub. No.: US 2013/0168885 A1
(43) Pub. Date: Jul. 4, 2013

(54) DEVICE AND METHOD FOR FORMATION OF VESICLES

(71) Applicants: DONNA M. OMIATEK, Rockville, MD (US); RENEE R. HOOD, College Park, MD (US); FRANCISCO JAVIER ATENCIA-FERNANDEZ, Madrid (ES); DON L. DEVOE, College Park, MD (US); WYATT N. VREELAND, Washington, DC (US)

(72) Inventors: DONNA M. OMIATEK, Rockville, MD (US); RENEE R. HOOD, College Park, MD (US); FRANCISCO JAVIER ATENCIA-FERNANDEZ, Madrid (ES); DON L. DEVOE, College Park, MD (US); WYATT N. VREELAND, Washington, DC (US)

(21) Appl. No.: 13/733,882

(22) Filed: Jan. 3, 2013

Related U.S. Application Data
(60) Provisional application No. 61/582,846, filed on Jan. 4, 2012.

(51) Int. Cl. B01J 13/00

(52) U.S. Cl. CPC B01J 13/00
USPC 264/4.1; 425/71

(57) ABSTRACT

A device and method for the formation of vesicles is disclosed herein. The device comprises a fluid introduction zone and a vesicle formation zone. The fluid introduction zone comprises a first inlet and a second inlet configured and disposed to provide parallel flow of an outer flow stream, flowing from the first inlet, sheathing an inner flow stream, flowing from the second inlet. The vesicle formation zone is configured and disposed to receive the parallel flow of the outer flow stream sheathing the inner flow stream and configured for a controlled and substantially uniform dispersion of an organic material, flowing in the inner flow stream, at a plane perpendicular to the vesicle formation zone.

### CROSS-REFERENCE TO RELATED APPLICATIONS

This application claims the benefit of U.S. Provisional Application No. 61/582,846, filed Jan. 4, 2012, and is incorporated herein by reference.

### STATEMENT REGARDING FEDERALLY SPONSORED RESEARCH OR DEVELOPMENT

This work is funded by the National Institute of Standards and Technology under the U.S. Department of Commerce.

### FIELD OF THE INVENTION

This invention relates to a device and method for the formation of vesicles, and more particularly toward a device and method for creating an outer aqueous flowing stream sheathing an organic stream containing amphiphilic molecules for the formation of vesicles.

### BACKGROUND

Traditionally, a vesicle is a small structure within a biological cell. This structure is enclosed by lipid bilayer. Currently, vesicles may be made naturally (in vivo) or artificially (in vitro), and in both cases they may be unilamellar—having only one phospholipid bilayer; or multilamellar—having more than one phospholipid bilayer. Artificially prepared vesicles are often called liposomes. Liposomes are formed when phospholipids and their derivatives are dispersed in water. Upon dispersion in water the phospholipids form closed vesicles or liposomes, which are characterized by lipid bilayer(s) substantially encapsulating an aqueous core. Various liposomes have been used as carriers for administration of nutrients and pharmaceutical drugs and enzymes, and in genetic sequencing.

Liposomes are composite structures made primarily of phospholipids and often small amounts of other molecules. Further liposomes may encapsulate other molecules in their aqueous core or in their lipid bilayer membrane. Though liposomes can vary in size from tens of nanometers to tens of micrometers, unilamellar liposomes, are typically in the lower size range and may have various targeting ligands attached to their surface allowing for their surface-attachment and accumulation in pathological areas for treatment of disease. Liposomes of different geometries, size and/or shape ranges, may be used for targeting delivery. For example, the in vivo bioavailability of liposomes may exhibit a strong dependence on size and geometry/shape of the liposomes. Thus, providing liposomes of selected size and/or geometry may better enable designing drug delivery carriers for targeting specific tissue or disease biomarkers.

Traditional liposome preparation methods may be based on mixing of bulk phases of fat-soluble and water-soluble constituents leading to inhomogeneous chemical and/or mechanical conditions during formation. Therefore, liposomes prepared by those traditional methods are often polydisperse in size and lamellarity. Controlled mixing of said phases may provide the ability to better control the liposome size and size distribution, or polydispersity; key elements to their potential use in various applications. Conventional modes of liposome preparation may require the mixing of two or more phases, typically liquid-liquid or liquid-solid, resulting in the spontaneous self-assembly of the lipid mixture into a spherical membrane structures. These conventional modes of liposome formation in vivo may provide any one of many different sets of mechanical and chemical conditions during its self-assembly, which may lead to liposome preparations with large polydispersity with respect to size and lamellarity.

What is needed is a device and method for a more controlled formation of vesicles with a smaller polydispersity, with respect to size, shape, and/or lamellarity.

### SUMMARY

In one aspect of the present disclosure, a device configured for the formation of vesicles comprises a fluid introduction zone and a vesicle formation zone. The fluid introduction zone comprises a first outlet and a second outlet configured and disposed to provide parallel flow of an outer flow stream, flowing from the first outlet, sheathing an inner flow stream, flowing from the second outlet. The vesicle formation zone is configured and disposed to receive a parallel flow of the outer flow stream, flowing from the first outlet, sheathing the inner flow stream, flowing from the second outlet, and configured for a controlled and substantially uniform dispersion of an organic material, flowing in the inner flow stream, at a plane perpendicular to the vesicle formation zone. The vesicle formation zone has an outlet.

In another aspect of the present disclosure, a process for the formation of vesicles comprises the steps of flowing an aqueous stream and flowing an organic stream centrally into and parallel with the flow of the aqueous stream. The aqueous stream completely sheaths the organic stream. The process further comprises dispersing a miscible organic material, flowing in the organic stream, with the aqueous stream that forms vesicles at the interface between the two streams.

In yet another aspect of the present disclosure, a device configured for the formation of vesicles comprises a longitudinally extending sheath configured and disposed for the flowthrough of an aqueous stream and a parallel flowing organic stream. The longitudinally extending sheath comprises an aqueous stream inlet configured and disposed to receive the aqueous stream into the sheath, an organic stream inlet configured and disposed to receive a parallel flowing organic stream centrally within the aqueous stream, and an outlet.

### BRIEF DESCRIPTIONS OF THE DRAWINGS

The following figures, which are idealized, are not to scale and are intended to be merely illustrative and non-limiting;

FIG. 1 shows a parallel flow device configured for the formation of vesicles;

FIG. 2 shows an exploded view of a section of the parallel flow device for the formation of vesicles of FIG. 1;

FIG. 3A shows another aspect of a parallel flow device for the formation of vesicles;

FIG. 3B shows a further aspect of a parallel flow device for the formation of vesicles;

FIG. 4 is an illustration of a mechanism of action for liposome formation using the parallel flow device for the formation of vesicles of the present disclosure;

FIG. 5 shows the mutual dispersion of miscible fluids in a vesicle formation zone of the parallel flow device for the formation of vesicles of the present disclosure;

FIG. 6 shows the dispersion of a material at specific cross-sections of a vesicle formation zone of the parallel flow device for the formation of vesicles of the present disclosure;

FIG. 7 graphically shows the size and polydispersity of liposomes formed with the device and method of the present disclosure as compared to other devices and methods;

FIG. 8 graphically shows liposome size and polydispersity with respect to selected diameters of a feed line inlet feeding an organic material to the vesicle formation zone of the parallel flow device for the formation of vesicles of the present disclosure;

FIG. 9 graphically shows liposome size with respect to a center organic/lipid containing line inserted at varying distances beyond the termination of a multi-line assembly containing an aqueous phase, in the parallel flow device of FIG. 1; and

FIG. 10 graphically shows liposome size with respect to varying flow rate ratios of an organic stream with an aqueous stream.

### DETAILED DESCRIPTION

Disclosed herein is a parallel flow device configured to create an outer aqueous flowing stream sheathing or surrounding an organic stream containing amphiphilic molecules for the formation of vesicles and a method for the formation of vesicles. An aspect of the device comprises an outer longitudinally extending sheath configured for the flow through of an outer stream of an aqueous fluid that sheaths an inner organic stream flowing parallel with the aqueous stream. A central feed line is configured and disposed for the parallel flow of the organic stream into a central portion of the aqueous stream. The organic stream may contain a mixture of amphiphilic molecules, such as phospholipids. The outer sheathing may create physicochemical conditions in the aggregate co-flowing streams that are substantially symmetric about a cross-section of the co-flowing streams. As the mutually miscible aqueous and organic streams disperse or diffusively mix, the amphiphilic molecules may self-assemble into liposomal vesicles. Adjustment of the flow rates and the device dimensions may provide for control of the resultant vesicle size and/or size distribution.

An aspect of the vesicle formation device comprises a series of plastic, glass, and/or metal lines configured and disposed to establish an outer aqueous stream that substantially sheaths a parallel flowing inner organic stream. The device may comprise a fluid introduction zone and a vesicle formation zone.

The presently disclosed device may provide for a simple, facile method of vesicle preparation at the point of application, and may reduce or obviate the need for time-consuming size homogenization processing steps. Thus, the presently disclosed device may enable wide adoption and implementation of novel, state-of-the-art therapeutic agents in hitherto unknown scales. Further, the presently disclosed device may allow for preparative-scale vesicle formation. Further, the presently disclosed device may produce vesicles with polydispersities lower than the polydispersities of currently used devices.

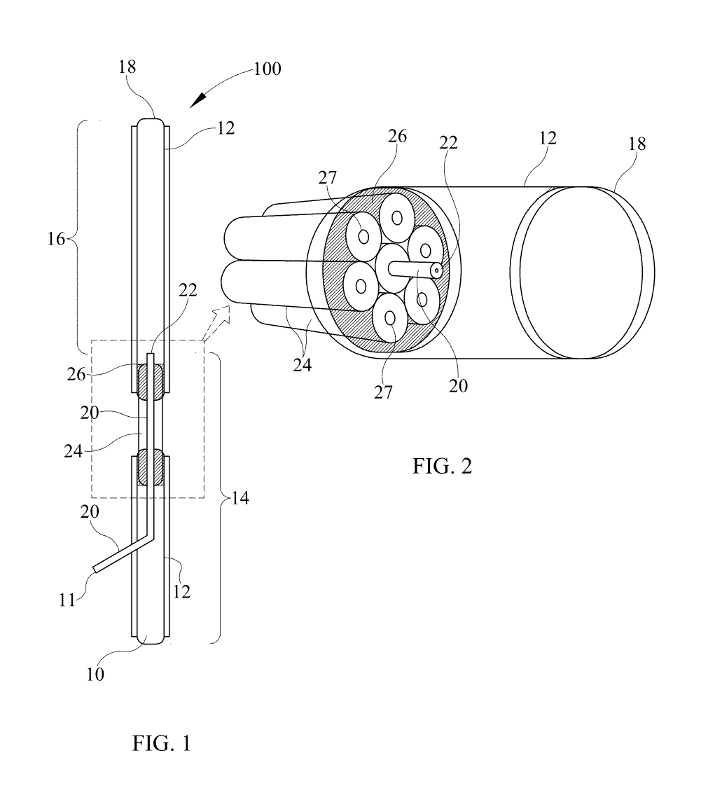

FIG. 1 shows parallel flow device 100 configured for the formation of vesicles and

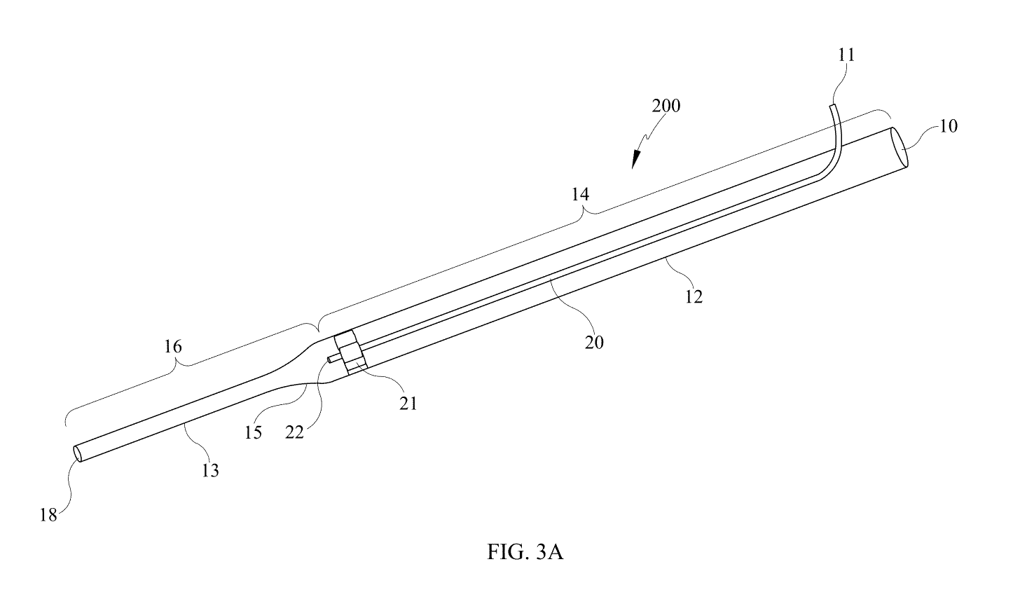

FIG. 2 shows an exploded view of a section of parallel flow device 100. Device 100 has a fluid introduction zone 14 and a vesicle formation zone 16. Fluid introduction zone 14 has a longitudinally extending sheath 12 disposed about ends of a plurality of outer feed lines 24. Outer feed lines 24 may be secured in end portions of sections of outer sheath 12 with an adhesive, sealer, or other material 26 proximate ends thereof. Outer feed lines 24 may each have terminal end or outlet 27 in a common plane. Material 26 is optional and may not be required as sheath 12 may extend from sheath inlet 10 to sheath outlet 18, about the plurality of outer feed lines 24. In at least one aspect, material 26 is a sealer and is configured and disposed to restrict the flow of liquids through the plurality of outer feed lines 24 to outlets 27. Central feed line 20 is disposed in a center of outer feed lines 24 and may extend beyond the terminal ends, or outlets 27, of the plurality of outer feed lines 24.

Sheath 12 has an inlet 10 configured and disposed for receiving an aqueous fluid flow. Central feed line 20 has an inlet 11 configured and disposed for receiving an organic fluid flow. Central feed line outlet 22 is downstream or at a greater distance from sheath inlet 10 than a plane common with the outlets 27 of the plurality of outer feed lines 24.

Vesicle formation zone 16 comprises a length of outer sheath 12 and extends from central feed line outlet 22 to sheath outlet 18. In the aspect shown in FIGS. 1 and 2, device 100 has an outer annular longitudinally extending sheath 12 and central feed line 20 configured and disposed for feeding an intra-annular organic stream into a parallel flowing annular sheathing aqueous stream being fed into sheath 12. However, it is to be understood that sheath 12 and/or central feed line 20 may have other than annular or round configurations. For example, sheath 12 and/or central feed line 20 may be rectangular, square, triangular, or have other geometric configurations.

Fluid introduction zone 16 may comprise a plurality of outer feed lines 24 disposed adjacent an inner surface of outer longitudinally extending sheath 12, each of the plurality of outer feed lines 24 may have a terminating end, with an outlet 27, in a plane substantially perpendicular to outer longitudinally extending sheath 12 and each outer feed line 24 may be configured for a flow through of an aqueous stream. A first outlet of fluid introduction zone 14 may comprise the terminating ends of the plurality of outer feed lines 27. A second outlet of fluid introduction zone 14 may comprise outlet 22 of central feed line 20. The first outlet may be upstream from the second outlet.

Device 100 may comprise sheath 12 in the form of a relatively large diameter poly(vinyl chloride) (PVC) line and central feed line 20 may be in the form of a relatively small diameter poly(ether ether ketone) (PEEK) tube. The PEEK tubing may be laterally inserted into the center of the PVC tubing substantially distal to the vesicle formation zone 16. Using a pump, an organic stream may be introduced into the PEEK tubing at central feed line inlet 11, and with a second pump, an aqueous stream may be introduced into the larger PVC line at sheath inlet 10.

In at least one aspect, fluid introduction zone 14 and vesicle formation zone 16 are separate component parts of device 100. For example, vesicle formation zone 16 may be mated with the fluid introduction zone 14. In this aspect, the inner diameter of the PVC tubing, or sheath 12, in fluid introduction zone 14 may be slightly larger than the outer perimeter of the plurality of outer feed lines 24. Thus, fluid introduction zone 14 may be inserted into and sealed with vesicle formation zone 16 with a small amount of material 26, such as a sealer, epoxy, or glue.

The plurality of outer feed lines 24 may comprise six outer glass lines arranged around the perimeter of a central line. For example, a glass multi-barrel pipette, or section thereof, may comprise a central glass line with six glass lines about its circumference, providing a bundle of seven glass lines. Each glass line may have an internal diameter on the order of 0.58 mm for example. Viewing the terminating ends of the glass lines axially, as seen in FIG. 2, the section may appear something like a daisy. Central feed line 20, in fluid introduction zone 14, may comprise PEEK tubing configured for the flowthrough of an organic stream and may be threaded into a central glass line of the bundle of seven glass lines until it protrudes a few millimeters, or other selected distance, past the terminus or outlets 27 of the plurality of outer feed lines 24. This configuration may create radially symmetric physicochemical conditions of fluids flowing into vesicle formation zone 16 and allow for substantially monodisperse vesicle preparations.

In at least one aspect of device 100, a section of sheath 12 in vesicle formation zone 16 comprises the same PVC tubing as the section of sheath 12 in introduction zone 14. Fluid introduction zone 14 may be mated to the terminal end of vesicle formation zone 16 and sealed with epoxy or glue. At vesicle formation zone's 16 terminus, or sheath outlet 18, a fluid containing vesicles may be collected and ready for use, further manipulation, or analysis.

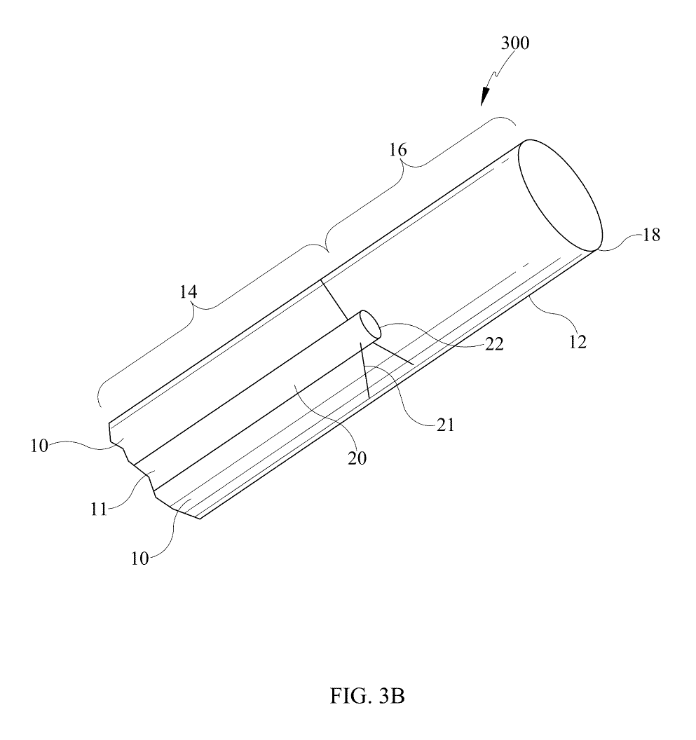

FIG. 3A shows parallel flow device 200 configured for the formation of vesicles. Device 200 has a fluid introduction zone 14 and a vesicle formation zone 16. Fluid introduction zone 14 has a longitudinally extending sheath 12 disposed about central feed line 20. Sheath 12 has an inlet 10 configured and disposed for receiving an aqueous fluid flow. Central feed line 20 has an inlet 11 configured and disposed for receiving an organic fluid flow. Central feed line outlet 22 is disposed centrally with longitudinally extending sheath 12. Support 21 is configured and disposed to centrally support central feed line outlet 22 in sheath 12. Support 21 may be any material or component configured to centrally support central feed line 20 in sheath 12, for example support 21 may be a section of a multi-barrel pipette.

Vesicle formation zone 16 comprises an inwardly tapered portion 15 and a smaller diameter portion 13, of outer sheath 12. Smaller diameter portion 13 terminates with sheath outlet 18. In the aspect of the vesicle formation device shown in FIG. 3A, central feed line outlet 22 may be positioned at varying positions proximate to or within inwardly tapered portion 15. In this manner, the flow rate ratio of a an organic fluid flowing out of central feed line outlet 22 with respect to a parallel flowing fluid, flowing through outer sheath 12, may be changed or varied.

Fluid introduction zone 14, of vesicle formation device 200, may comprise a first and a second outlet. The first outlet may be in flow communication with inlet 10 and configured and disposed provide a flow of an aqueous stream surrounding or sheathing an organic fluid stream, flowing from a second outlet or central feed line outlet 22. Outer sheath 12 may have inwardly tapered portion 15, proximate second outlet 22, of fluid introduction zone 14, and a longitudinally extending portion 13, extending from inwardly tapered portion 15 to outlet 18 of vesicle formation zone 16. Second outlet 22 may be movable about a longitudinal axis of outer sheath 12, with respect to inwardly tapered portion 15. In this respect, a flow rate ratio between fluids flowing from the first outlet and the second outlet out may be adjusted.

Parallel flow device 200 may provide for the formation of vesicles with a controlled proportion of an organic/alcohol stream, flowing through central feed line 20, with respect to a volume of an aqueous stream, flowing through outer sheath 12, in vesicle formation zone 16. This configuration may result in a higher concentration of vesicles, which may be desirable. Additionally, the structure or plumbing may be more robust and may radially center the central organic/alcohol stream, flowing through central feed line 20, proximate an exact middle of the parallel flowing outer aqueous stream, flowing through outer sheath 12. Therefore, the use of a tapered capillary or pipette as outer sheath 12, and a rigid central feed line 20, such as stainless steel/fused silica capillary insert, may provide and a more rigid structure. Additionally, providing support 21 configured for the movement of central line 20 therein, may provide an improved method of adjusting or tuning the flow rate ratios of the parallel flowing organic and aqueous streams.

In at least one aspect parallel flow device 200, outer sheath 12 having tapered portion 15 and a smaller diameter portion 13, comprises a standard glass Pasteur pipette. A polymeric tube, such as Tygon®, may be sealed about the larger opening end of the pipette and central feed line 20 may be extended through the wall of the polymeric portion of outer sheath 12. In this respect, central feed line 20 may have inlet 11 disposed outside and apart from sheath inlet 10 for the introduction of different fluids into each inlet 10 and 11.

FIG. 3B shows parallel flow device 300. Device 300 has a fluid introduction zone 14 and a vesicle formation zone 16. Fluid introduction zone 14 has a longitudinally extending sheath 12 disposed about central feed line 20. Sheath 12 has an inlet 10 configured and disposed for receiving an aqueous fluid flow. Central feed line 20 has an inlet 11 configured and disposed for receiving an organic fluid flow. Central feed line outlet 22 is disposed centrally with longitudinally extending sheath 12. Support 21 is configured and disposed to centrally support central feed line outlet 22 in sheath 12. Support 21 may be any type of support, as is known by persons having ordinary skill in the art, configured and disposed to support central feed line outlet 22 centrally within sheath 12.

Device 300 may be configured for the formation of vesicles and may comprise fluid introduction zone 14 and vesicle formation zone 16. Fluid introduction zone 14 may comprise a first outlet about central feed line outlet 22, in flow communication with inlet 11, and a second outlet, central feed line outlet 22, configured and disposed to provide parallel flow of an outer flow stream, flowing from the first outlet, sheathing an inner flow stream, flowing from the second outlet. Vesicle formation zone 16 may be configured and disposed to receive a parallel flow of the outer flow stream, flowing from the first outlet, sheathing the inner flow stream, flowing from the second outlet, and may be configured for a controlled and substantially uniform dispersion of an organic material, flowing in the inner flow stream, at a plane perpendicular to vesicle formation zone 16.

Vesicle formation zone 16 has outlet 18 and may comprise central feed line 20 and outer longitudinally extending sheath 12 having an inner diameter greater than an outer diameter of central feed line 20. Central feed line 20 may have a second outlet 22 centrally disposed in outer longitudinally extending sheath 12. A first outlet of fluid introduction zone 14 may be in flow communication with inlet 10 and surround second outlet 22. The first outlet may be disposed a distance from outlet 18, of vesicle formation zone 16, greater than or equal to a distance of second outlet 22 from outlet 18. Vesicle formation zone 16 may be configured for a flow through of an organic stream, flowing form second outlet 22, at a volumetric flow rate less than or equal to a volumetric flow rate of an aqueous stream, flowing from the first outlet. The first outlet may be disposed about an outer perimeter second outlet 22. Device 300 may comprise a unitary outer sheath 12 extending throughout fluid introduction zone 14 and vesicle formation zone 16 and may be annular, for example outer sheath 12 may be a tube, or pipe.

In at least one aspect of the present disclosure, a device configured for the formation of vesicles comprises a longitudinally extending sheath 300 configured and disposed for the flowthrough of an aqueous stream and a parallel flowing organic stream. The sheath may comprise an aqueous stream inlet 10, configured and disposed to receive an aqueous stream into sheath 12, and organic stream inlet 11, configured and disposed to receive a parallel flowing organic stream centrally within the aqueous stream, and an outlet 18. The aqueous stream inlet 10 may be disposed at a distance greater than or equal to a distance of organic stream inlet 22, from outlet 18 of sheath 12. Aqueous stream inlet 10 may be configured for a first volumetric flow rate and organic stream inlet 22 may be configured for a second volumetric flow rate of an aqueous stream. The first volumetric flow rate may be greater than or equal to the second volumetric flow rate.

In at least one aspect of the present disclosure, a device for the formation of vesicles comprises an outer longitudinally extending sheath 12 having a fluid introduction zone 14, a vesicle formation zone 16, and a vesicle outlet 18. Sheath 12 is configured for a flow through of an aqueous stream. A longitudinally extending feed line 20 is disposed in outer longitudinally extending sheath 12 and is configured for a flow through of an organic stream. Sheath 12 has an inner diameter greater than an outer diameter of feed line 20. Feed line 20 and sheath 12 are configured and disposed for a parallel flow of an aqueous stream about an organic stream into vesicle formation zone 16. The device may be configured for a controlled and substantially uniform dispersion of an organic material in the organic stream at a plane perpendicular to vesicle formation zone 16.

Outer sheath 12 may be configured and disposed to create an aqueous flowing stream sheathing a parallel flowing organic flowing stream in at least a portion of vesicle formation zone 16, during the formation of vesicles. The device may comprise a plurality of longitudinally extending outer feed lines 24 disposed adjacent an inner surface of outer sheath 12, as shown in FIG. 1, and each having a terminating end, or outlet 27, in a plane substantially perpendicular to outer longitudinally extending sheath 12. Each longitudinally extending outer feed line 24 may be configured for a flow through of an aqueous stream. The device may comprise a terminating plane of each one of the plurality of feed lines, or outlets 27, at a distance from outlet 18 greater than or equal to a distance of a terminating end, or outlet 22, of central feed line 20, from outlet 18. The device may have vesicle formation zone 16 configured for a flow of an organic stream through central feed line 20 at a volumetric flow rate less than or equal to a volumetric flow rate of an aqueous stream flowing in parallel through sheath 12. Vesicle formation device 300 may have a smaller cross-sectional flow area of central feed line 20 than a cross-sectional flow area about central feed line 20.

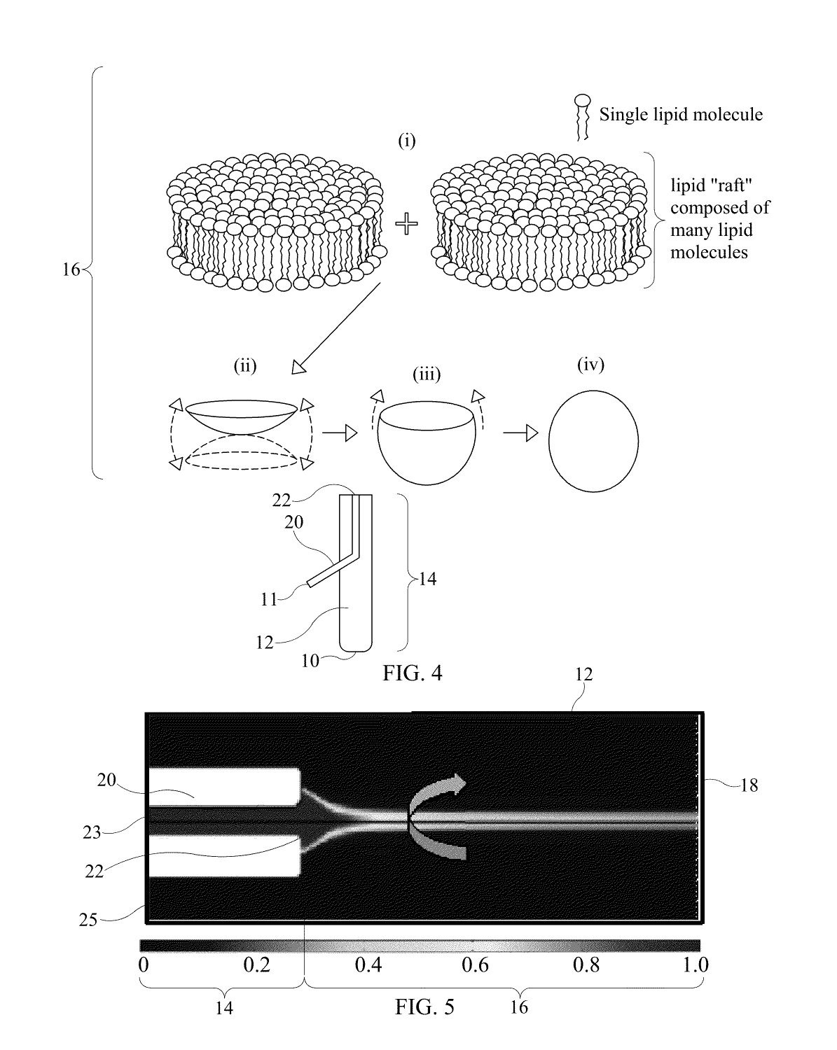

FIG. 4 shows a process and mechanism of action for liposome formation using the parallel flow device for the formation of vesicles of the present disclosure. A process for the formation of vesicles may comprise flowing an aqueous stream into longitudinally extending sheath 12, via sheath inlet 10. An organic stream may then be centrally fed into longitudinally extending sheath 12 and parallel with the flow of the aqueous stream. The organic stream may be fed through central feed line 20, via inlet 11, and into the aqueous stream through outlet 22. A miscible organic material in the organic stream is then dispersed with the aqueous stream in vesicle formation zone 16 and vesicles may be expelled from outlet 18.

For example, an organic stream containing one or more organic molecules, such as amphiphilic molecules, or phospholipids and their derivatives, may be fed into vesicle formation zone 16 through vesicle introduction zone outlet, or vesicle formation zone inlet, 22. An aqueous stream may be fed into vesicle formation zone 16 through vesicle introduction zone inlet 10, or a vesicle formation zone inlet disposed about inlet 22. The organic molecules may then disperse throughout the co-flowing streams as lipid “rafts” depicted in (i). Liposomes may then be spontaneous self-assembled with the lipid mixture assembling into a spherical bilayer membrane in vesicle formation zone 16, as depicted in (ii), (iii), and (iv). Upon dispersion in water, the phospholipids may form closed vesicles called or liposomes, which may be characterized by lipid bilayers substantially encapsulating an aqueous core or form a spherical bilayer membrane. The outer sheathing of the organic stream with the aqueous stream may create physicochemical conditions in the aggregate co-flowing streams that are substantially symmetric about a cross-section of the co-flowing streams. As the mutually miscible aqueous and organic streams disperse or diffusively mix, as shown in (i), the amphiphilic molecules may self-assemble into liposomal vesicles, as shown in (ii)-(iv).

FIG. 5 shows the mutual dispersion of miscible fluids in vesicle formation zone 16 of the parallel flow device for the formation of vesicles of the present disclosure. Outer annular longitudinally extending sheath 12 has aqueous solution 25 flowing about a perimeter of central feed line 20 to sheath line outlet 18. Central feed line 20 is parallel feeding an organic containing solution 23 into a central portion of flowing aqueous solution 25. This parallel flow of organic stream 23 with aqueous stream 25, into vesicle formation zone 16, may provide for feeding an intra-annular organic stream into a parallel flowing annular sheathing aqueous stream. This may result in a device configured for controlled and substantially uniform dispersion of an organic material in the co-flowing streams, at a plane perpendicular to vesicle formation zone 16.

FIG. 5 shows a numerical model of an alcohol/water, stream 23 flowing through central feed line 20, mixing, diffusing, or dispersing, just post exit 22 from an inner PEEK tube 20. In this gray scale model it is shown that alcohol, represented by the dark gray central longitudinal portion extending from central feed line 20, is distributed along a channel diameter of outer sheath 12. The aqueous flow is represented by the dark gray outer flow portion adjacent the inner wall of outer sheath 12. As can be seen with the controlled reduction of alcohol in the central stream, a controlled dispersion of alcohol is exhibited through the co-flowing streams. FIG. 5 shows that the outer flowing aqueous stream sheathes and focuses the central alcohol stream. In this respect, a mutual diffusion of miscible fluids, in an alcohol stream and a aqueous stream, may enable the assembly of spherical vesicles at the solvent interface due to a change in amphiphile solubility.

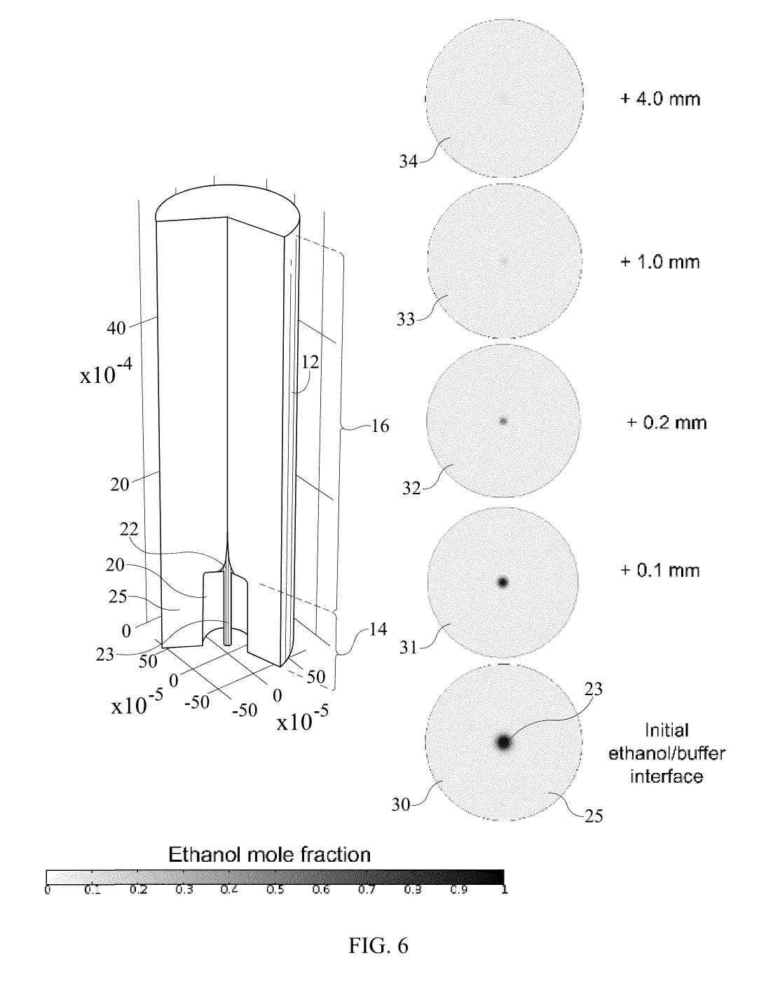

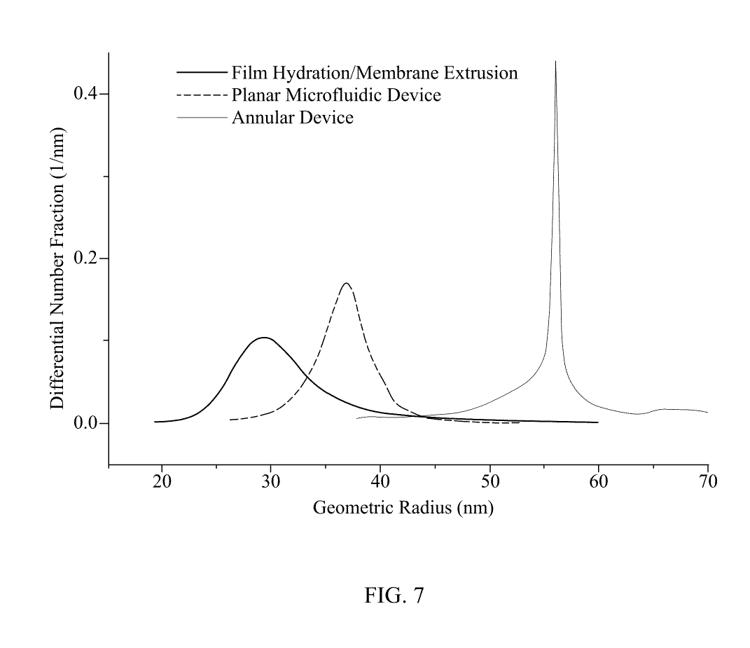

FIG. 6 shows the dispersion of an organic material at specific cross-sections of a vesicle formation zone 16. Flowing an organic material containing stream 23, through central feed line 20, and into aqueous stream 25, via outlet 22, may provide a substantially controlled and uniform dispersion of the organic material with the aqueous stream. Outer sheathing of organic stream 23, with aqueous stream 25, may create physicochemical conditions in the aggregate co-flowing streams that are substantially radially symmetric. The vesicle formation device may be configured to provide a controlled and substantially uniform dispersion of an organic material and ethanol/buffer, in organic stream 23, with aqueous stream 25 at a plane perpendicular to vesicle formation zone 16, as shown in cross-sectional diagrams 30-34.

Vesicle formation zone 16 may be configured and disposed to receive a parallel flow of the outer flow stream 25, flowing from a first outlet, sheathing the inner flow stream 23, flowing from a second outlet, and may be configured for a controlled and substantially uniform dispersion of an organic material, flowing in the inner flow stream, at a plane perpendicular to vesicle formation zone 16.

Cross-sectional concentration diagrams 30-34 data were rendered from data generated with a finite-element numerical modeling software package that use a creeping-flow (i.e. low Re flow) limit of the Navier-Stokes equations coupled with a convection-diffusion equation. A alcohol/water mixture may have a viscosity that is great than either liquid in pure form, therefore a plot of viscosity as a function of alcohol concentration in water may have a roughly parabolic shape with a maxima at ˜60% EtOH in water. Hence, the diffusion coefficients may have a minima at the same concentration conditions. A 5th order polynomial fit of data was employed to account for the viscosity of alcohol/water mixture and any heats of mixing were neglected as they may be negligible.

Cross-sectional diagram 30 shows an initial ethanol concentration, with ethanol being delivered through central line 20, in fluid flowing through outer sheath 12, adjacent exiting outlet 22. Cross-sectional diagrams 31, 32, 33, and 34 show ethanol concentrations in fluid flowing through outer sheath 12 at 0.1 mm, 0.2 mm, 1.0 mm, and 4.0 mm, respectively. It is shown that the dispersion of the alcohol flowing from outlet 22 into the flow of fluid in outer sheath 12 is greatest adjacent to outlet 22. As the fluids proceed from outlet 22, the rate of dispersion decreases. The rate of decrease in dispersion along the length of outer sheath 12 may indicate that mass diffusion, as opposed to mixing of the miscible fluids, may be the predominate mechanism driving the dispersion of alcohol. Therefore, the parallel flow device for making vesicles of the present disclosure may provide for a controlled dispersion of an organic material with an aqueous solution and provide a control production of liposome size and/or polydispersity.

FIG. 7 graphically shows the size of liposomes formed with the device and method of the present disclosure, shown as annular device, as compared to other devices and methods. As shown in FIG. 7, the polydispersity of the size of liposomes may be significantly less than the polydispersity of size of liposomes obtained by film hydration/membrane extrusion and planar microfluidic devices. This is represented with the larger height showing a greater differential number fraction and the narrowness of the curve showing a lower range of geometric radius.

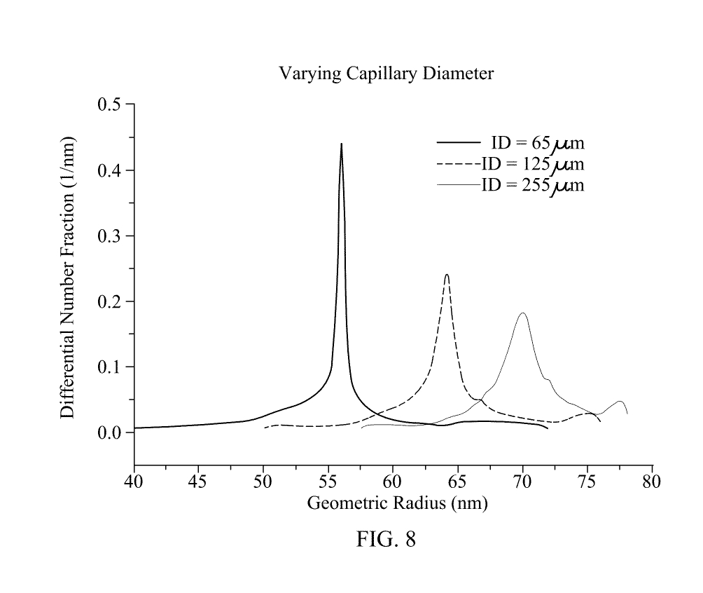

FIG. 8 graphically shows liposome size with respect to selected diameters of a feed line inlet 22 feeding an organic material to the vesicle formation zone 16 of the parallel flow device for the formation of vesicles of the present disclosure. An organic/alcohol stream was fed into vesicle formation zone 16 with different feed lines, each having a different inner diameter. Specifically, a first feed line 20 and outlet 22 had an inner diameter of 65 μm; a second feed line 20 and outlet 22 had an inner diameter of 125 μm; and a third feed line 20 and outlet 22 had an inner diameter of 255 μm. As shown in FIG. 8, the size, or geometric radius, and the polydispersity, or differential number fraction, of the liposomes may be controlled with different sizes or inner diameters of feed lines 20 and outlets 22. In each example shown, each feed line 20 had an equivalent inner diameter as its outlet 22. The results show that a smaller inner diameter results in less polydispersity and smaller size liposomes.

In aspects of the present disclosure, second outlet 22 of fluid introduction zone has an inner diameter of at most 255 μm, advantageously at most 125 μm, and more advantageously at most 65 μm.

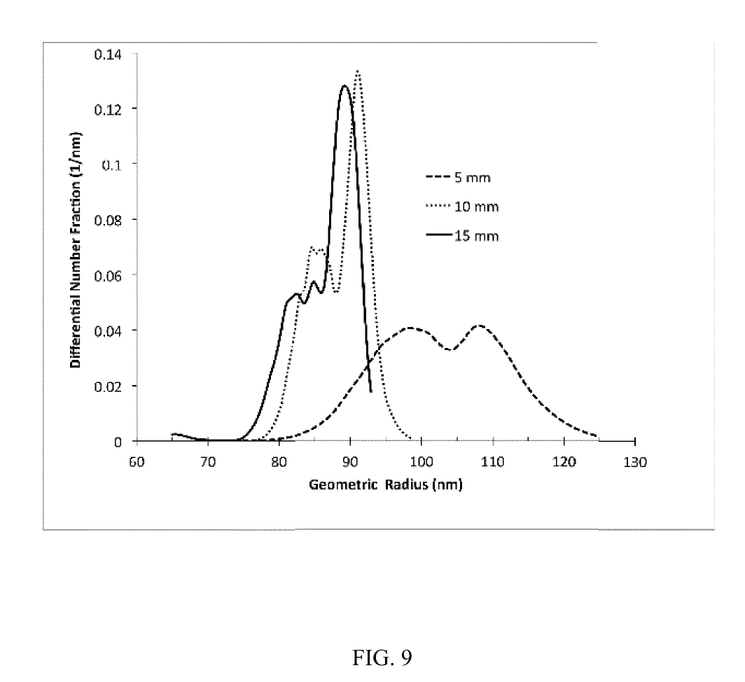

FIG. 9 graphically shows liposome size with respect to a center organic/lipid containing line 20 inserted at varying distances beyond the termination of a multi-line assembly 24 containing an aqueous phase, in the parallel flow device of FIG. 1. Liposome preparations were made with the center organic/lipid containing line 20 inserted 5 mm, 10 mm and 20 mm beyond the plane of termination of outer feed lines 24, or inlets 27, of the multi line assembly containing the aqueous phase. The operation conditions were: center line ID=65 um; volumetric flow rate ratio=5,000:1; aqueous flow rate=1000 μL/min; and organic/lipid flow rate=0.2 μL/min. The plots in FIG. 9 show that increasing the distance between outlets 22, of central line insert 20, and outlets 27, of outer feed lines 24, provides liposomes having less polydispersity. This may be due to eddy currents being present in the aqueous flow stream adjacent outlets 27. Having outlet 22 further downstream may provide a more stable axial flow of the aqueous fluid flowing from outlets 27 prior to the introduction of the organic stream through outlet 22.

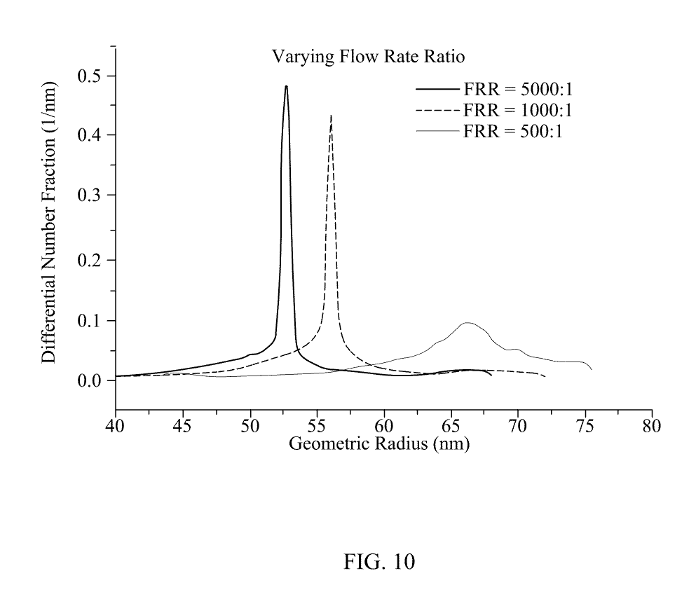

FIG. 10 graphically shows liposome size with respect to varying flow rate ratios of an organic stream with an aqueous stream. Varying the flow rate ratios may be accomplished by varying the pumping rate of fluids into inlets 10 and/or 11 or by longitudinally moving central feed line 20 to dispose outlet 22 at a different point in inwardly tapered portion 15 of outer sheath 12, as shown in vesicle forming device 300 in FIG. 3. It is shown in FIG. 10 that varying the flow rate of the aqueous stream with respect to the flow rate of the organic stream may control liposome size and polydispersity. For example, increasing the flow rate ratio (aqueous flow rate:organic flow rate) from 500:1 to 1000:1 significantly decreases both polydispersity and size of the liposomes formed. A further increase of the flow rate ratio to 5000:1 further decreases both polydispersity and size of the liposomes formed. A greater decrease in both polydispersity and size of the liposomes formed was shown with the increase in the flow rate ratio from 500:1 to 1000:1 than from 1000:1 to 5000:1.

Aspects of the parallel flow device of the present disclosure are configured for a flow rate ratio of a flow of an aqueous stream from a first outlet of fluid introduction zone 14 to a flow of an organic stream from a second outlet of fluid introduction zone 14 between about 500:1 to about 10000:1, advantageously between about 1000:1 to about 7500:1, and more advantageously the flow rate ratio is about 5000:1.

A process for the formation of vesicles is disclosed herein. The process may comprise the steps of flowing an aqueous stream and flowing an organic stream centrally into and parallel with the flow of the aqueous stream, whereby the flowing aqueous stream completely sheaths or surrounds the flowing organic stream. A miscible organic material, flowing in the organic stream, may be dispersed with the aqueous stream and vesicles may form. The flowing of the aqueous stream and organic stream may comprise flowing the aqueous stream and the organic stream at a flow rate ratio between about 500:1 to about 10000:1. A device or process system may be adjustable and an adjustment to the flow rate ratio may be made by moving an outlet of the organic stream about a longitudinal axis of a sidewall, through which the aqueous stream is flowing, with respect to an inwardly tapered portion of the sidewall.

Aspects of the presently disclosed parallel flow device and methods may provide for the formation of liposomes that encapsulate reagents in a continuous 2-phase flow microfluidic network with precision control of size, for example, from 100 nm to 300 nm, by manipulation of liquid flow rates are described. By creating a solvent-aqueous interfacial region in a microfluidic format that is homogenous and controllable on the length scale of a liposome, fine control of liposome size and/or polydispersity may be achieved.

To best mimic biological systems, it may be desirable to create environments that are controllable on the dimension of the particle itself to elicit fine control of nanometer scale synthesis and self-assembly processes. Therefore, aspects of the present disclosure may provide for the formation of liposomes in microfluidic systems, the characteristics of fluidic flow in a micrometer-scale parallel flow device be used to precisely control the distribution of chemical conditions and mechanical forces so that they are substantially constant on a length scale equivalent to that of a liposome. Hence, forming liposomes in a micrometer-scale flow field may results in more homogenous conditions during liposome self-assembly and resultant liposome populations that are more uniform in size, hence of low polydispersity.

Thus, the present disclosure includes methods for producing a liposome-containing composition, which includes: providing a solvent stream of a composition of lipids or lipid-forming materials dissolved in a solvent through a central microchannel having a hydrodynamic diameter of 100 μm or less, preferably 70 μm or less; and centrally entering a solvent stream into a parallel flowing aqueous stream of an aqueous composition which hydrodynamically focuses the solvent stream and forms an aqueous sheath about the solvent stream having an interfacial region where the solvent stream and the aqueous stream disperse or diffuse into each other to provide conditions such that liposomes self-assemble from the lipids or lipid-forming materials.

When the two liquid phases come into contact, the solvent phase and aqueous phase may rapidly diffuse into one another. The flow rates of the solvent and aqueous streams may be adjusted to control the degree of hydrodynamic focusing and ultimately the liposome size. The lipids self-assemble where the concentration of the solvent phase containing the lipid or lipid-forming materials and the aqueous composition is at a critical condition where lipids are no longer soluble and thus self-assemble into liposomes. The formed liposomes may remain centrally in a microchannel or tube because: (i) liposomes formed along the interfacial region may follow stream lines and may be directed to collect at the center point in the channel; and (ii) at this point the solvent may have diluted to a concentration where it can no longer solubilize any fraction of the lipid.

One may control the liposome size by altering the ratio of the flow rate in the sheathing inlet channel(s) compared to the central inlet channel. This may results in a decrease or increase in both the mean and range (polydispersity) of liposome diameter. Thus, by tuning of the flow rates in the inner and outer parallel flow streams, the physical characteristics of the resultant liposome preparation may be changed or controlled.

A useful characteristic of liposomes is their ability to encapsulate (or perhaps excapsulate) ionic molecules from a surrounding aqueous medium. Thus, the present disclosure includes embodiments wherein a reagent is included in the composition of lipids or lipid-forming materials and/or in the aqueous composition and at least a portion of the reagent is encapsulated (or excapsulated) in the liposomes. Examples of reagents which may be encapsulated in liposomes as part of the above-described methods include small molecules (for example, drugs, fluorescent molecules, amino acids) and large molecules (for example, proteins, peptides, polymers, DNA and RNA).

The lipid or lipid-forming materials used in the central feed line 20 to make liposomes include all known materials for liposome formation. Examples of useful materials include combinations of phospholipid molecules and cholesterol. Particularly preferred are combinations of dimyristoylphosphatidylcholine, cholesterol, and dicetylphosphate. These materials may be provided in a solvent that will dissolve the lipid or lipid-forming materials. The solvent may also be water miscible in order to diffuse or disperse into the aqueous composition. Examples of useful solvents include alcohols, such as isopropanol, methanol or ethanol. The lipids or lipid-forming materials may be provided in the solvent in a concentration of approximately 10 mM-50 mM.

The aqueous composition may be an aqueous buffer solution, particularly a phosphate-buffered saline solution, phosphate buffer, TRIS buffer or HEPES buffer. By changing the length scale of the vesicle formation zone 12, flow rate ratio of aqueous solution to organic solution, and/or diameter of central line 20, fine control of liposome size and homogeneity may be provided. Particularly, liposome-containing compositions with liposomes having a mean diameter from about 10 nm to about 300 nm and a size distribution of 15 to 20% may be produced using the herein described devices and methods. The parallel flow device of the present disclosure may provide for the adjustment of the flow fields using the simple principle of hydrodynamic focusing, thus enabling the production of substantially monodisperse populations without the need for subsequent processing steps to modify liposome size.

The liposome self-assembly method described herein may be used to provide liposomes for in vivo applications and for on-demand drug encapsulation and delivery and may be scaled up or down providing microfluidics devices or larger production scale devices.

From the foregoing description, one skilled in the art may ascertain the essential characteristics of this invention and, without departing from the spirit and scope thereof, may make various changes and modifications of the invention to adapt it to various usages and conditions.

1. A device configured for the formation of vesicles comprising:
a fluid introduction zone and a vesicle formation zone;
said fluid introduction zone comprising a first outlet and a second outlet configured and disposed to provide parallel flow of an outer flow stream, flowing from said first outlet, sheathing an inner flow stream, flowing from said second outlet; and
said vesicle formation zone being configured and disposed to receive a parallel flow of the outer flow stream, flowing from said first outlet, sheathing the inner flow stream, flowing from said second outlet, and configured for a controlled and substantially uniform dispersion of an organic material, flowing in the inner flow stream, at a plane perpendicular to said vesicle formation zone, and said vesicle formation zone having an outlet.

2. The device for the formation of vesicles of claim 1 wherein said fluid introduction zone comprises a central feed line and an outer longitudinally extending sheath, said outer longitudinally extending sheath having an inner diameter greater than an outer diameter of said central feed line, said central feed line having said first outlet centrally disposed in said outer longitudinally extending sheath.

3. The device for the formation of vesicles of claim 2 wherein said fluid introduction zone further comprises a plurality of outer feed lines disposed adjacent an inner surface of said outer longitudinally extending sheath, each said plurality of outer feed lines having a terminating end in a plane substantially perpendicular to said outer longitudinally extending sheath and each being configured for a flow through of an aqueous stream, said first outlet of said fluid introduction zone comprising said terminating ends of said plurality of outer feed lines.

4. The device for the formation of vesicles of claim 3 wherein said first outlet of said fluid introduction zone is at a distance from said outlet of said vesicle formation zone greater than or equal to a distance of said second outlet of said fluid introduction zone from said outlet of said vesicle formation zone.

5. The device of claim 1 wherein said vesicle formation zone is configured for a flow through of an organic stream, flowing form said second outlet of said fluid introduction zone, at a volumetric flow rate less than or equal to a volumetric flow rate of an aqueous stream, flowing from said first outlet of said fluid introduction zone.

6. The device of claim 1 wherein said second outlet of said fluid introduction zone has an inner diameter of at most 255 μm.

7. The device of claim 1 configured for a flow rate ratio of a flow from said first outlet of said fluid introduction zone to a flow from said second outlet of said fluid introduction zone between about 500:1 to about 10000:1.

8. The device of claim 2 wherein said outer sheath has an inwardly tapered portion, proximate said second outlet of said fluid introduction zone, and a longitudinally extending portion, extending from said inwardly tapered portion to said outlet of said vesicle formation zone.

9. The device of claim 8 wherein said second outlet is movable about the longitudinal axis of said outer sheath, with respect to said inwardly tapered portion of said outer sheath.

10. The device of claim 1 wherein said vesicle formation zone is annular.

11. A process for the formation of vesicles comprising the steps of:
flowing an aqueous stream;
flowing an organic stream centrally into and parallel with the flow of the aqueous stream, whereby the aqueous stream completely sheaths the organic stream;
dispersing a miscible organic material, flowing in the organic stream, with the aqueous stream; and
forming vesicles.

12. The process of claim 11 wherein said steps of flowing an aqueous stream and flowing an organic stream comprises flowing the aqueous stream and the organic stream at a flow rate ratio between about 500:1 to about 10000:1.

13. The process of claim 12 further comprising a step of moving an outlet of the organic stream about a longitudinal axis of a sidewall, through which the aqueous stream is flowing, with respect to an inwardly tapered portion of the sidewall.

14. A device configured for the formation of vesicles comprising:
a longitudinally extending sheath configured and disposed for the flowthrough of an aqueous stream and a parallel flowing organic stream, said longitudinally extending sheath comprising:
an aqueous stream inlet configured and disposed to receive the aqueous stream into said sheath;
an organic stream inlet configured and disposed to receive a parallel flowing organic stream centrally within the aqueous stream; and
an outlet.

15. The device for the formation of vesicles of claim 14 wherein said aqueous stream inlet is at a distance greater than or equal to a distance of said organic stream inlet, from said outlet of said sheath.

16. The device for the formation of vesicles of claim 14 wherein said aqueous stream inlet is configured for a first volumetric flow rate and said organic stream inlet is configured for a second volumetric flow rate of an aqueous stream, said first volumetric flow rate is greater than or equal to said second volumetric flow rate.

17. The device for the formation of vesicles of claim 14 wherein said organic stream inlet has an inner diameter of at most 255 μm.

18. The device for the formation of vesicles of claim 16 configured for a flow rate ratio of the first volumetric flow rate to the second volumetric flow rate between about 500:1 to about 10000:1.

19. The device for the formation of vesicles of claim 14 wherein said longitudinally extending sheath is annular.

20. The device for the formation of vesicles of claim 14 wherein said longitudinally extending sheath has an inwardly tapered portion, proximate said organic stream inlet, and a longitudinally extending portion, extending from said inwardly tapered portion to said outlet, said organic stream inlet being movable about a longitudinal axis of said outer sheath, with respect to said inwardly tapered portion.
